(19) United States
(12) Patent Application Publication
(10) Pub. No.: US 2018/0095441 A1
(43) Pub. Date: Apr. 5, 2018

(54) LOAD DISTRIBUTION DEVICE

(71) Applicant: Mitsubishi Electric Corporation, Tokyo (JP)

(72) Inventors: Koichi NAKAGAWA, Tokyo (JP); Hiroshi ASHIYA, Tokyo (JP)

(73) Assignee: Mitsubishi Electric Corporation, Tokyo (JP)

(21) Appl. No.: 15/532,354

(22) PCT Filed: Feb. 15, 2016
(86) PCT No.: PCT/JP2016/054338

§ 371 Date: Jun. 1, 2017

(51) Int. Cl. G05B 19/05; G05B 21/02

(52) U.S. Cl. CPC G05B 19/052; G05B 2219/12; G05B 21/02

(57) ABSTRACT

A load distribution device includes: a combining unit to create a plurality of combinations for cases where each of a plurality of execution object programs is assigned to any one of a plurality of control devices; an estimating unit to estimate an all programs' completion time, which is a delay time taken from delivery of the plurality of execution object programs until return of execution results of the plurality of execution object programs to a delivery source, for each of the plurality of combinations created; and a selecting unit to select one combination whose all programs' completion time is shorter than a reference time, from the plurality of combinations created.

### FIELD

The present invention relates to a load distribution device for causing a plurality of execution object programs to be executed by a plurality of control devices.

### BACKGROUND

In a case where one control device executes a plurality of execution object programs, the processing burden of this control device becomes large. In consideration of this, there has been proposed a technique for causing a plurality of execution object programs to be executed by a plurality of control devices (for example, see Patent Literatures 1, 2, and 3). According to this technique, the processing burden for executing the plurality of execution object programs is distributed among a plurality of control devices, and thus the processing burden of each of the control devices becomes smaller.

If a plurality of execution object programs are assigned in a distributed state to a plurality of control devices, this shortens the all programs' completion time, which is a delay time taken from the delivery of the plurality of execution object programs until the return of execution results of the plurality of execution object programs to the delivery source. In other words, the all programs' completion time obtained in a case where a plurality of control devices share the burden of executing a plurality of execution object programs becomes shorter than the all programs' completion time obtained in a case where one control device executes the plurality of execution object programs.

### CITATION LIST

### Patent Literature

Patent Literature 1: Japanese Patent Application Laid-open No. H9-91011
Patent Literature 2: Japanese Patent Application Laid-open No. H9-160890
Patent Literature 3: Japanese Patent Application Laid-open No. 2002-140313

### SUMMARY

### Technical Problem

However, even if the conventional technique is used such that a plurality of control devices share the burden of executing a plurality of execution object programs, there is a problem in that the processing load of a specific control device is larger, as the case may be, and the all programs' completion time is still long in this case.

The present invention has been made in view of the above, and an object of the present invention is to provide a load distribution device that can further shorten the all programs' completion time.

### Solution to Problem

According to an aspect of the present invention, there is provided a load distribution device for causing a plurality of execution object programs to be executed by a plurality of control devices. The load distribution device includes: a specifying unit to specify each of the plurality of execution object programs as to which one of a plurality of types of program is; an obtaining unit to obtain information about an execution time of each of the plurality of types of program; a combining unit to create a plurality of combinations for cases where each of the plurality of execution object programs is assigned to any one of the plurality of control devices; an estimating unit to estimate an all programs' completion time, which is a delay time taken from delivery of the plurality of execution object programs until return of execution results of the plurality of execution object programs to a delivery source, for each of the plurality of combinations created by the combining unit, by presuming that execution times for respectively executing programs of a same type are equal to each other, and by using information caught by the specifying unit and information obtained by the obtaining unit; a selecting unit to select one combination whose all programs' completion time estimated by the estimating unit is shorter than a reference time, from the plurality of combinations created by the combining unit; and a controlling unit to assign each of the plurality of execution object programs to any one of the plurality of control devices in accordance with the one combination selected by the selecting unit, to be executed the plurality of execution object programs by the plurality of control devices.

### Advantageous Effects of Invention

The load distribution device according to the present invention has an effect capable of further shortening the all programs' completion time.

### BRIEF DESCRIPTION OF DRAWINGS

FIG. 1 is a configuration diagram of a load distribution system including a load distribution device according to a first embodiment.

FIG. 2 is a view illustrating details of a first PLC and an information terminal device, which constitute the load distribution system of FIG. 1.

FIG. 3 is a flowchart illustrating a program registration sequence in the first embodiment.

FIG. 4 is a view illustrating a storage example of signal registration information in the first embodiment.

FIG. 5 is a view illustrating a storage example of program information in the first embodiment.

FIG. 6 is a flowchart illustrating a sequence of selecting any one programmable logic controller from a plurality of programmable logic controllers and instructing it to execute a program.

FIG. 7 is a view for explaining synchronization of a program in the first embodiment.

FIG. 8 is a view illustrating a storage example of a program execution record in the first embodiment.

FIG. 9 is a view concerning a program execution time estimation process in the first embodiment.

FIG. 10 is a view for explaining the load distribution device according to the first embodiment.

FIG. 11 is a view illustrating combination examples created by the combining unit of FIG. 10.

FIG. 12 is a view illustrating a case where some of the units constituting the information terminal device of FIG. 10 are formed of a processing circuit.

FIG. 13 is a view illustrating a case where some of the units constituting the information terminal device of FIG. 10 are formed of a processor.

### DESCRIPTION OF EMBODIMENTS

An exemplary embodiment of a load distribution device according to the present invention will be explained below in detail with reference to the accompanying drawings. The present invention is not limited to the following embodiment.

### First Embodiment

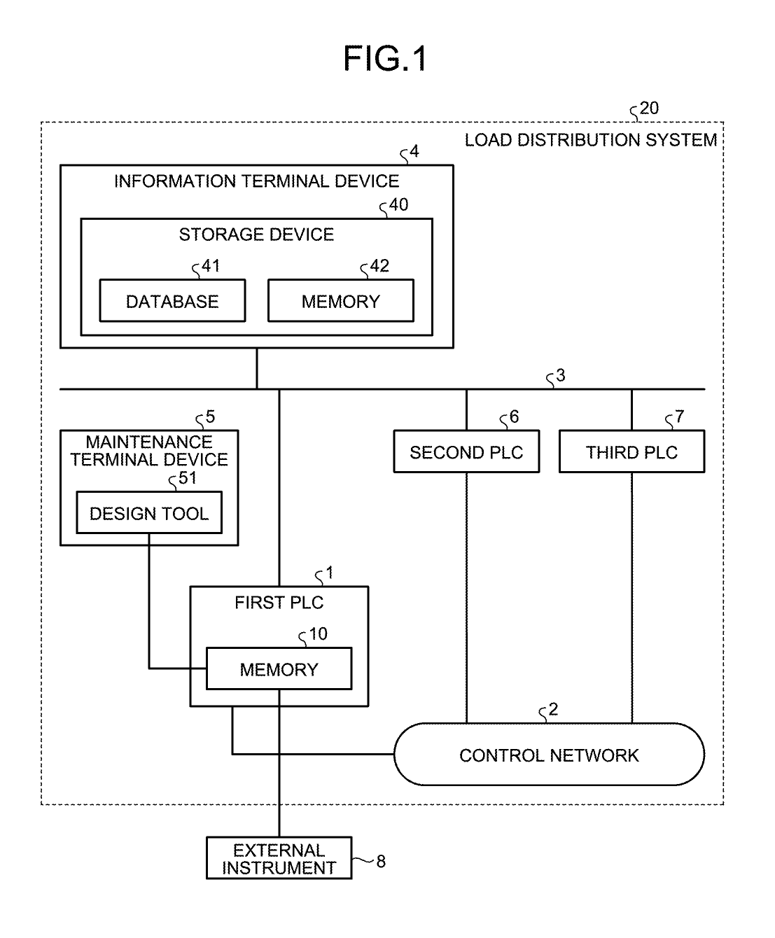

FIG. 1 is a configuration diagram of a load distribution system 20 including a load distribution device according to a first embodiment. The load distribution device according to the first embodiment is a device for arranging to share execution of a plurality of execution object programs by a plurality of control devices. In the first embodiment, the load distribution device is an information terminal device 4, and the control devices are programmable logic controllers. Hereinafter, each of the programmable logic controllers will be referred to as “PLC”. The “PLC” is an acronym for Programmable Logic Controller. However, each of the load distribution device and the control devices may be formed of an ordinary personal computer. Hereinafter, a personal computer will be referred to as “PC”. The “PC” is an acronym for Personal Computer.

As illustrated in FIG. 1, the load distribution system 20 includes a first PLC 1, a control network 2, an information network 3, an information terminal device 4, a maintenance terminal device 5, a second PLC 6, and a third PLC 7. The first PLC 1 is connected to an external instrument 8. An example of the external instrument 8 is a sensor, pump, or valve. An example of the sensor is a flowmeter or manometer.

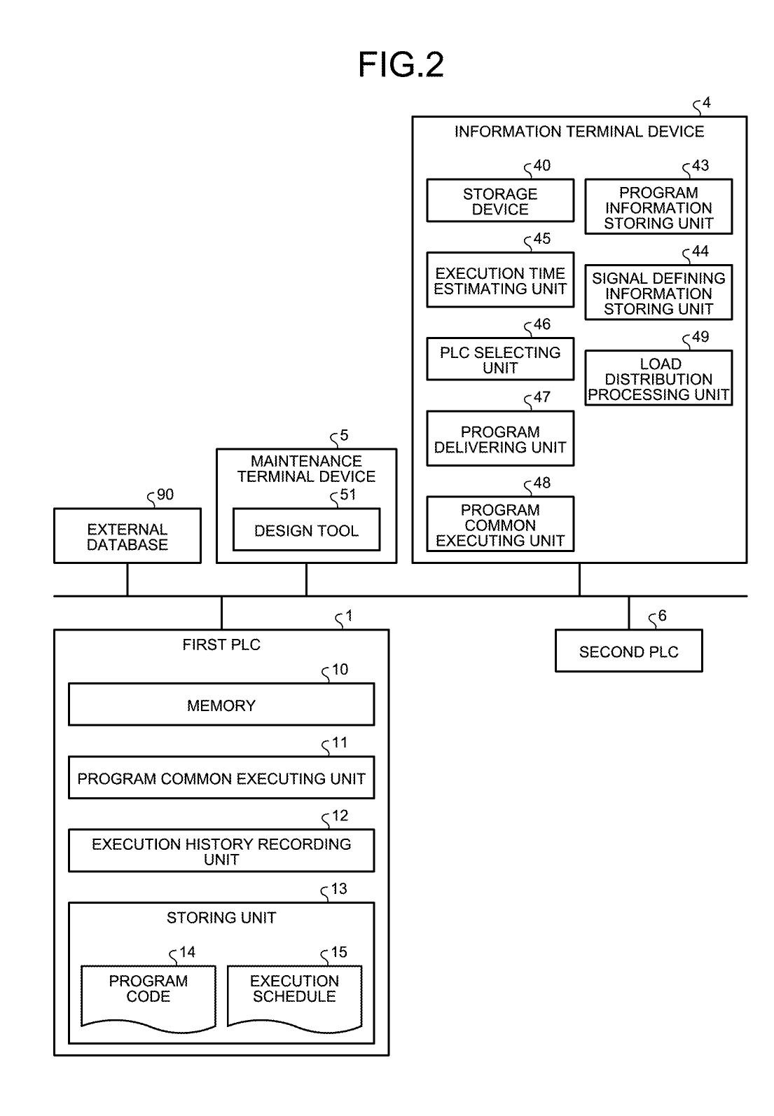

The first PLC 1 includes a memory 10. The maintenance terminal device 5 includes a design tool 51 that stores user programs. In the memory 10 of the first PLC 1, a user program from the design tool 51 of the maintenance terminal device 5 is stored. The first PLC 1 uses the user program stored in the memory 10 to obtain a value measured by a sensor of the external instrument 8 and to output a control signal to the external instrument 8. The first PLC 1 further includes components other than the memory 10. The components included in the first PLC 1, other than the memory 10, will be explained later with reference to FIG. 2.

The control network 2 is a communication network that mutually connects the first PLC 1, the second PLC 6, and the third PLC 7. The plurality of PLCs are connected to each other via the control network 2. The first PLC 1, the second PLC 6, and the third PLC 7 can exchange data with each other in real time by use of a shared memory in the control network 2. An example of the shared memory is a cyclic memory. For the sake of simplicity in explanation, the shared memory is not illustrated in FIG. 1.

The information network 3 is a communication network that mutually connects the information terminal device 4, the first PLC 1, the second PLC 6, and the third PLC 7. The information network 3 may be a local area network or may be an internet.

The information terminal device 4 is formed of a PC. The information terminal device 4 may be formed of a dedicated device other than a general-purpose PC. The information terminal device 4 communicates with each of the first PLC 1, the second PLC 6, and the third PLC 7 via the information network 3 in accordance with a communication protocol. An example of the communication protocol is TCP/IP (Transmission Control Protocol/Internet Protocol).

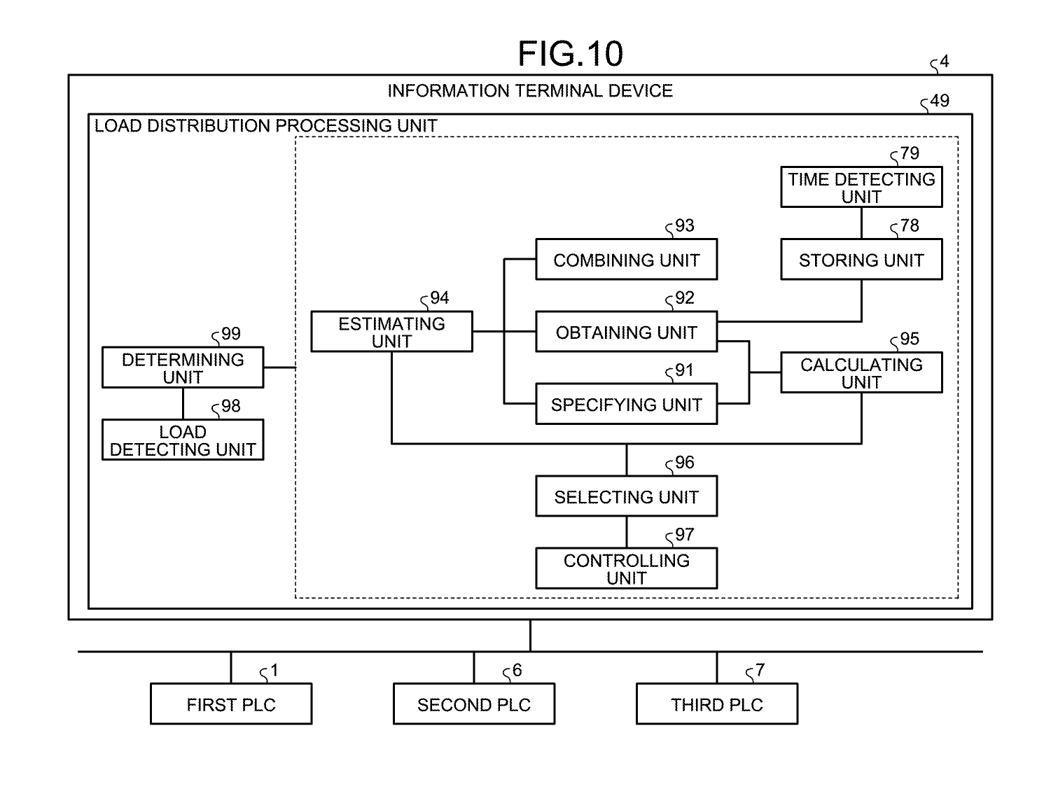

The information terminal device 4 is equipped with a storage device 40 including a database 41 and a memory 42. The memory 42 stores MES and ERP. The “MES” is an acronym for Manufacturing Execution System, which is information for maximizing production. The “ERP” is an acronym for Enterprise Resource Planning, which is information for maximizing profit. The information terminal device 4 observes data owned by the first PLC 1, stores the data owned by the first PLC 1 into the database 41, and transmits a signal for controlling the first PLC 1 to the first PLC 1. The information terminal device 4 further includes components other than the storage device 40. The components included in the information terminal device 4, other than the storage device 40, will be explained later with reference to FIGS. 2 and 10.

FIG. 2 is a view illustrating details of the first PLC 1 and the information terminal device 4, which constitute the load distribution system 20 of FIG. 1. FIG. 2 further illustrates the maintenance terminal device 5 and the second PLC 6. Furthermore, FIG. 2 illustrates an external database 90 that can communicate with each of the first PLC 1, the information terminal device 4, and the second PLC 6.

The first PLC 1 includes the memory 10, a program common executing unit 11, an execution history recording unit 12, and a storing unit 13. The storing unit 13 stores a program code 14 and an execution schedule 15, which are associated with an execution object program. The program code 14 is a code concerning a program cooperating with the MES and the ERP, which are stored in the memory 42 of the storage device 40 included in the information terminal device 4. The program common executing unit 11 is a unit for executing an execution object program associated with the program code 14. The execution history recording unit 12 is a unit for recording an execution time of the program associated with the program code 14, together with identification information of the program code 14, in time series.

The information terminal device 4 includes the storage device 40, a program information storing unit 43, a signal defining information storing unit 44, an execution time estimating unit 45, a PLC selecting unit 46, a program delivering unit 47, a program common executing unit 48, and a load distribution processing unit 49. The program information storing unit 43 stores program information that contains the value of the program code 14 associated with a program to be executed by the first PLC 1. The signal defining information storing unit 44 stores signal defining information that contains the name of a signal to be treated by the first PLC 1 and a connection destination for obtaining the value of the signal.

The execution time estimating unit 45 estimates a time necessary for executing a program when the program is executed next time, based on program information stored by the program information storing unit 43. The PLC selecting unit 46 selects a PLC to execute the program, based on the execution time estimated by the execution time estimating unit 45. The program delivering unit 47 delivers the program to the PLC selected by the PLC selecting unit 46. The program common executing unit 48 executes a process that enables a program to be executed also by a PLC other than the PLC selected by the PLC selecting unit 46.

The execution time estimating unit 45, the PLC selecting unit 46, and the program delivering unit 47 may be not provided in the information terminal device 4. The respective functions of the execution time estimating unit 45, the PLC selecting unit 46, and the program delivering unit 47 may be realized on a cloud, or may be realized by one or more PLCs connected to the information terminal device 4. The load distribution processing unit 49 will be explained later with reference to FIG. 10.

Next, an explanation will be given of an operation of the load distribution system 20 according to the first embodiment. This operation of the load distribution system 20 includes a sequence of registering a program to be executed by a PLC, and a sequence of selecting an optimum PLC from the plurality of PLCs and using the selected PLC to execute the program.

(Sequence 1: Program Registration)

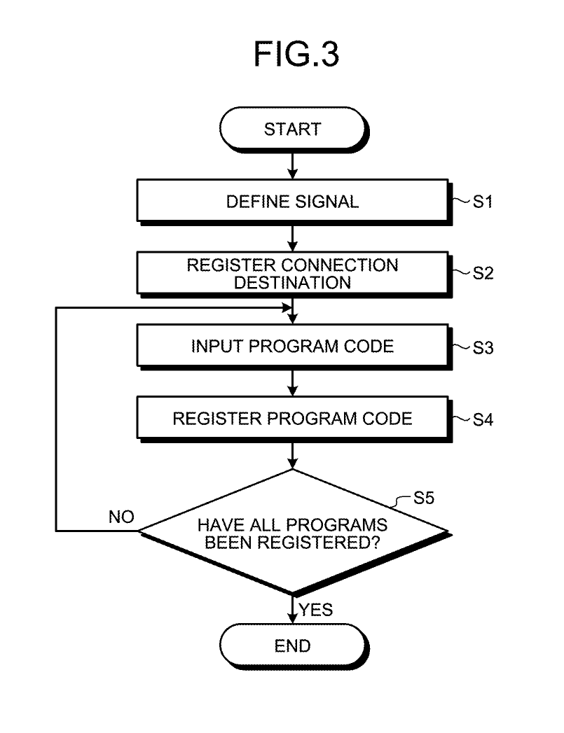

With reference to the flowchart of FIG. 3, the program registration sequence will be explained. FIG. 3 is a flowchart illustrating the program registration sequence in the first embodiment. In a step S1, the signal defining information storing unit 44 of the information terminal device 4 defines signals to be treated by an execution object program. In each of the first PLC 1, the second PLC 6, and the third PLC 7, signals from the information terminal device 4 are stored into a memory.

The following formula (1) is a formula showing an example of a program code according to the first embodiment.

DB1.INSERT(TB1,ID=1234,COUNT=TAG300); (1)

The formula (1) means that: the identification number of a product produced by certain equipment is indicated by an ID “1234”; the number of pieces of the product is expressed by “TAG300”; and this number of pieces is to be stored as a production history into a table TB1 of a database DB1. The table TB1 is formed with two fields, such that the first field is a field for an ID indicating a product identification number and the second field is a field for a COUNT illustrating the production number of pieces of a product. In the program code of the formula (1), signals concerning a database are DB1 and TB1, and a signal concerning a sensor is TAG300.

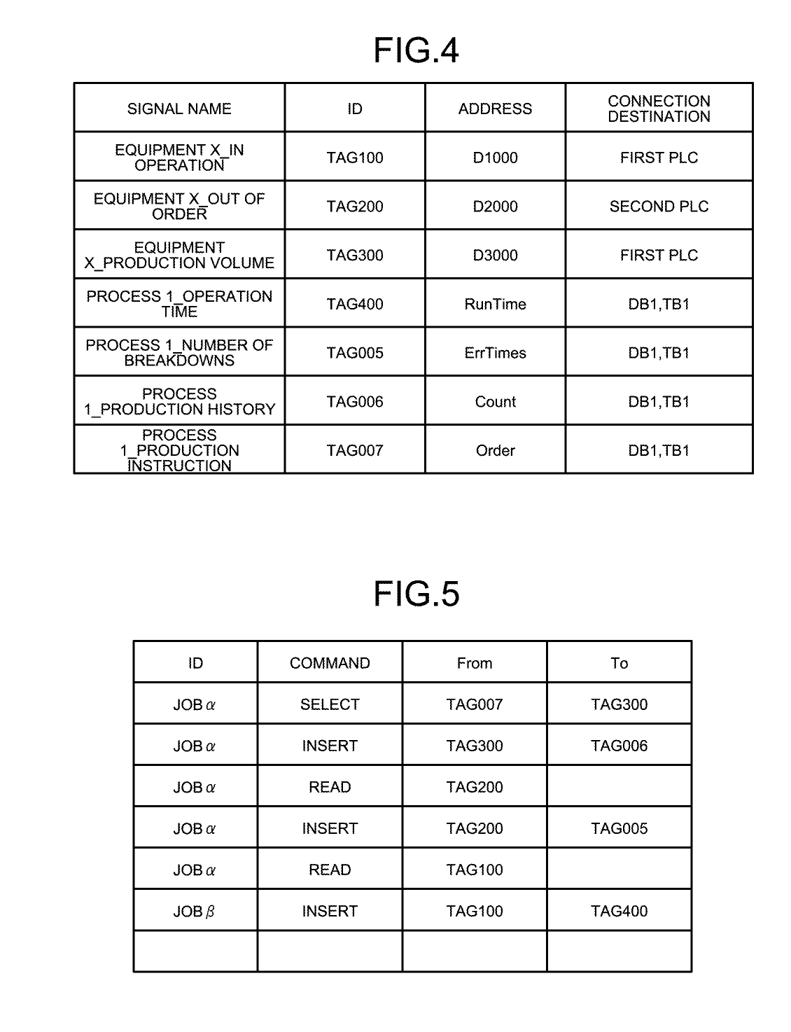

In a step S2, the signal defining information storing unit 44 of the information terminal device 4 registers a destination for obtaining a signal. The destination for obtaining a signal is a connection destination, and an example of the connection destination is a sensor or database. Specifically, the connection destination is a field in the table of the external database 90 or a PLC. For example, where a limit sensor for measuring a production volume provided in equipment X is connected to the first PLC 1, and a value of the number of pieces, which is a value measured by the limit sensor, is stored in an address D3000, the connection destination is the first PLC 1 as illustrated in FIG. 4.

FIG. 4 is a view illustrating a storage example of signal registration information in the first embodiment. In FIG. 4, there are defined, as attributes, a signal name expressing the meaning of a signal, an ID for identifying a signal, an address assigned to a signal, and a connection destination serving as a destination for obtaining the value of a signal. The address mentioned above is replaced by a field in the database. FIG. 4 shows, about the limit sensor described above, that: the signal name is “equipment X production volume”; the ID for identifying the signal in the system is “TAG300”; and its value can be obtained by making reference to the address D3000 of the first PLC 1.

A signal with an ID “TAG200” is a signal indicating that: the equipment X is out of order; and the content of the signal with the ID “TAG200” can be obtained by reading an address D2000 of the second PLC 6. FIG. 4 shows, about a signal with an ID “TAG400, that: this signal is a signal indicating the operation time of a process 1; and the content of this signal is stored in a field “RunTime” in the table TB1 of the external database DB1.

In a step S3 in FIG. 3, the signal defining information storing unit 44 of the information terminal device 4 describes the content of the program code 14 into the program information storing unit 43 by use of the design tool 51 of the maintenance terminal device 5. At this time, a signal ID registered in the signal registration information is used.

In step S4, the design tool 51 of the maintenance terminal device 5 registers the program code 14 into the program information storing unit 43. At this time, the design tool 51 registers relevant information into the program information storing unit 43, where the relevant information indicates which program operates which signal and how this operation is performed. An example of the operation is extraction or insertion. In the first embodiment, the extraction is expressed by SELECT, and the insertion is expressed by INSERT. The program information registered in the program information storing unit 43 indicates program attributes. By designating a program name or program identification information, it is found which PLC memory address the program is to be used at, or which database table field the program is to operate and how this operation is performed.

FIG. 5 is a view illustrating a storage example of the program information in the first embodiment. For example, FIG. 5 shows that a program JOBα reads the value of a signal TAG007 from the database and writes it into a signal TAG300. As illustrated in FIG. 4, the signal TAG007 is a production instruction, and the value of the signal TAG007 is obtained by reading a part “Order” in a field of the table TB1 of the database DB1. The signal of the writing destination is the signal TAG300. As illustrated in FIG. 4, the signal TAG300 indicates the production volume of the equipment X, and so the value of the signal TAG007 is written into the address D3000 of the first PLC 1.

In a step S5 in FIG. 3, if registration for all the programs has been completed (Yes in the step S5), the program registration ends. If registration for all the programs has not yet been completed (No in the step S5), the process shifts to the step S3.

### (Sequence 2: PLC Selection and Program Execution)

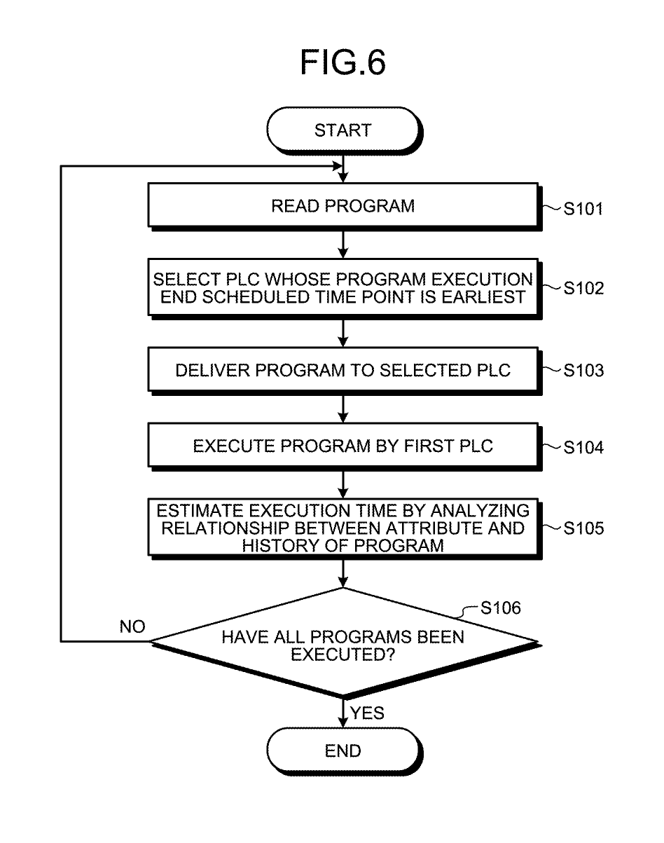

FIG. 6 is a flowchart illustrating a sequence of selecting any one PLC from the plurality of PLCs and instructing the selected PLC to execute a program. In a step S101, the execution time estimating unit 45 of the information terminal device 4 reads a registered program from the program information storing unit 43.

In a step S102, the execution time estimating unit 45 of the information terminal device 4 obtains an estimated time taken until execution of the program currently executed ends. If the estimated time is 0, the PLC selecting unit 46 selects a PLC whose execution end scheduled time point is earliest, from the execution schedule 15 of PLCs currently connected to the information terminal device 4. If the estimated time is not 0, the PLC selecting unit 46 selects a PLC that comes to have the smallest value when the estimated time is added to the execution end scheduled time point of the PLC. For example, it is assumed that: the estimated time is 40 seconds; the program currently executed in the first PLC 1 is scheduled to end after 20 seconds; the program currently executed in the second PLC 6 is scheduled to end after 10 seconds; and the program currently executed in the third PLC 7 is scheduled to end after 80 seconds. In this case, the PLC selecting unit 46 selects the second PLC 6, and renews the execution end scheduled time point by adding 40 to the execution schedule 15.

In a step S103, the program delivering unit 47 of the information terminal device 4 delivers a program to the PLC selected by the PLC selecting unit 46. The delivery is performed in accordance with a general-purpose protocol. An example of the general-purpose protocol is HTTP/FTP (Hypertext Transfer Protocol/File Transfer Protocol).

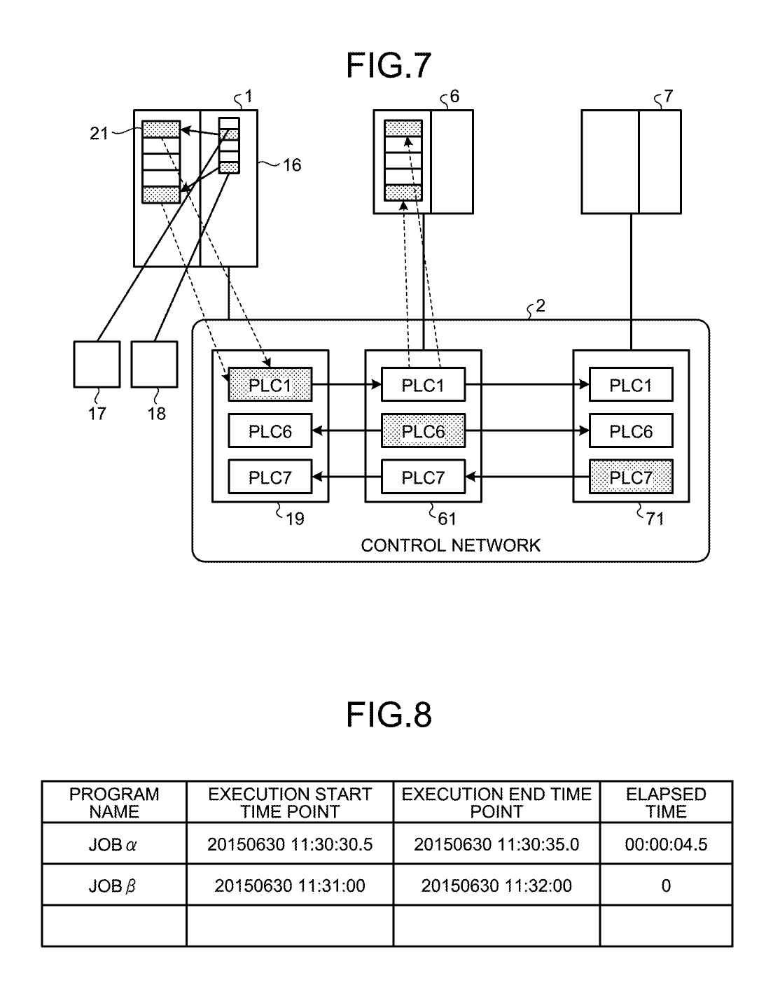

The delivered program is controlled by the program common executing unit 48 of the information terminal device 4, such that the program is to be executed by every one of the PLCs. Here, with reference to FIG. 7, a detailed explanation will be given of that the delivered program is executed by every one of the PLCs. FIG. 7 is a view for explaining synchronization of a program in the first embodiment. A program for treating the first sensor 17 and the second sensor 18 is executed by the first PLC 1, the second PLC 6, and the third PLC 7. A signal from the first sensor 17 is input into the second terminal of an I/O terminal unit 16 provided in the first PLC 1, and a signal from the second sensor 18 is input into the fifth terminal of the I/O terminal unit 16. The values of the signals input into the first PLC 1 are respectively written at the first address and the fifth address of a local memory 21 in the first PLC 1 by the CPU of the first PLC 1.

The second PLC 6 includes a local memory whose addresses have a configuration the same as the configuration of the addresses of the local memory in the first PLC 1, but the second PLC 6 does not include an I/O terminal unit 16, and so the values measured by the first sensor 17 and the second sensor 18 are not written into the local memory in the second PLC 6. However, the first PLC 1, the second PLC 6, and the third PLC 7 are provided with cyclic memories in the control network 2. The cyclic memories serve as a common memory to the first PLC 1, the second PLC 6, and the third PLC 7.

The cyclic memories include areas respectively for the first PLC 1, the second PLC 6, and the third PLC 7. Specifically, there are present a first cyclic memory 19 corresponding to the first PLC 1, a second cyclic memory 61 corresponding to the second PLC 6, and a third cyclic memory 71 corresponding to the third PLC 7. When data is written into an area for the first PLC 1 in the first cyclic memory 19, this data is copied into an area for the first PLC 1 in the second cyclic memory 61. Similarly, this data is copied into an area for the first PLC 1 in the third cyclic memory 71.

While the measurement value of the first sensor 17 is being written into the memory 10 of the first PLC 1, a process for writing this value at any one of the addresses of the first cyclic memory 19 and a process for writing this value into the memory of the second PLC 6 from any one of the addresses of the second cyclic memory 61 for the second PLC 6 are performed. Because the first PLC 1, the second PLC 6, and the third PLC 7 share the cyclic memories, even if the value is supposed to be written into the memory 10 of the first PLC in accordance with a program, the program can be executed by every one of the PLCs. As the program common executing unit 48 of the information terminal device 4 causes the processes described above to be performed, even if a program is delivered to the first PLC 1, the delivered program can be executed by the second PLC 6 and the third PLC 7.

In a step S104 in FIG. 6, the first PLC 1 executes the program. Before executing the program, the first PLC 1 stores a program ID that identifies the program and an execution start time point of the program into the execution history recording unit 12. After ending execution of the program, the first PLC 1 detects entry of the program ID, and, as illustrated in FIG. 8, the first PLC 1 stores the execution end time point into the execution schedule 15 and records the elapsed time therein. FIG. 8 is a view illustrating a storage example of a program execution record in the first embodiment. FIG. 8 shows that execution of a program JOBα started on Jun. 30, 2015 at 11:30:30.5 and ended on Jun. 30, 2015 at 11:30:35.0. Thus, the elapsed time was 4.5 seconds.

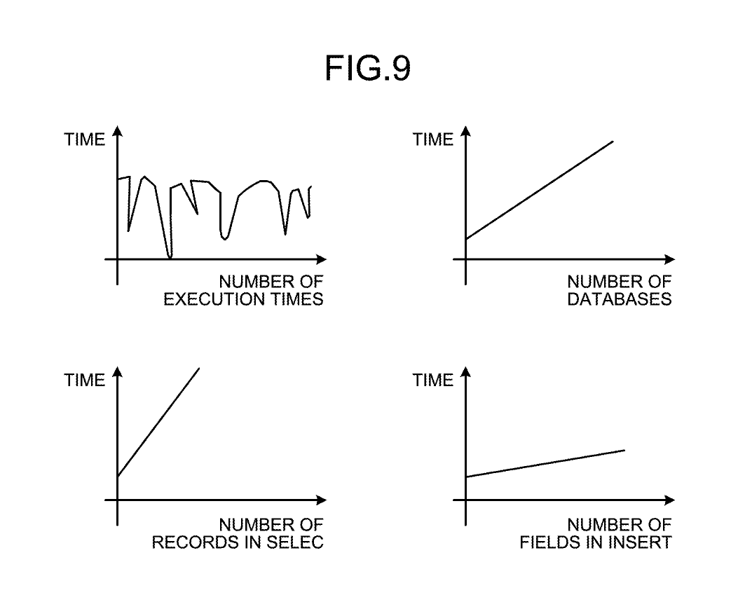

In a step S105 in FIG. 6, the execution time estimating unit 45 estimates an execution time by analyzing the causal relationship between the execution time history of the program and the attributes of the program included in the program information. FIG. 9 is a view concerning a program execution time estimation process in the first embodiment. As illustrated in FIG. 9, the program execution time is in proportion to the number of databases in connection, the number of records, and the number of fields.

The execution time estimating unit 45 statistically analyzes the relationship between an external factor and the execution time. For example, the execution time estimating unit 45 analyzes the time necessary for reading data from the memory of a specific PLC. The execution time estimating unit 45 performs formulation of the estimated time, based on the causal relationship derived from a result of the analysis. This formulation is modeling in other words. For the modeling, a widely known method is used. An example of the widely known method is a least square method.

For example, it is assumed that the program execution time Ti is modeled as in the following formula (2).

Ti=1.5×(the number of databases in communication)×1,000+2.2×(the number of table columns) (2)

Where the number of databases is 2, and the number of table columns is 1,000, the program execution time can be estimated to be 5,200 ms, by use of the formula (2). At this time, a value obtained by adding Ti to the current time point is recorded into the field of the execution schedule 15 for the execution end time point. Further, 0 is recorded into the field for the elapsed time, by which the estimated time and the history can be discriminated from each other. Then, if execution for all the programs has be completed (Yes in S106), the process ends. If execution for all the programs has not yet been completed (No in S106), the process shifts to the step S101.

Next, a detailed explanation will be given of a load distribution device for causing a plurality of execution object programs to be executed by a plurality of control devices. FIG. 10 is a view for explaining the load distribution device according to the first embodiment. As described above, in the first embodiment, the load distribution device is the information terminal device 4. For the sake of simplicity in explanation, FIG. 10 illustrates only the load distribution processing unit 49 among a plurality of components included in the information terminal device 4. As described above, in the first embodiment, the control devices are PLCs. Specifically, in the first embodiment, the plurality of control devices are the first PLC 1, the second PLC 6, and the third PLC 7.

In the first embodiment, the following conditions are assumed in relation to the plurality of execution object programs and execution times. Specifically, the plurality of execution object programs consist of nine programs, which are a program A1, a program A2, a program A3, a program B1, a program B2, a program B3, a program C1, a program C2, and a program C3. The program A1, the program A2, and the program A3 are programs of a type A. The program B1, the program B2, and the program B3 are programs of a type B. The program C1, the program C2, and the program C3 are programs of a type C. For example, the programs of the type A are programs about cutting, the programs of the type B are programs about machining, and the programs of the type C are programs about assembling.

In the first embodiment, the execution time of a program of the type A is an execution time “a”. Namely, the execution time of every one of the program A1, the program A2, and the program A3 is the execution time “a”. The execution time of a program of the type B is an execution time “b”. Namely, the execution time of every one of the program B1, the program B2, and the program B3 is the execution time “b”. The execution time “b” is shorter than the execution time “a”. The execution time of a program of the type C is an execution time “c”. Namely, the execution time of every one of the program C1, the program C2, and the program C3 is the execution time “c”. The execution time “c” is longer than the execution time “a”. The sum of the execution time “a” and the execution time “b” is equal to the execution time “c”.

As illustrated in FIG. 10, the load distribution processing unit 49 of the information terminal device 4 includes a specifying unit 91, an obtaining unit 92, a combining unit 93, an estimating unit 94, a calculating unit 95, a selecting unit 96, a controlling unit 97, a load detecting unit 98, a determining unit 99, a time detecting unit 79, and a storing unit 78.

The specifying unit 91 specifies each of the plurality of execution object programs as to which one of the plurality of types of program is. Specifically, the specifying unit 91 specifies that the program A1, the program A2, and the program A3 among the plurality of execution object programs are programs of the type A. The specifying unit 91 specifies that the program B1, the program B2, and the program B3 among the plurality of execution object programs are programs of the type B. The specifying unit 91 specifies that the program C1, the program C2, and the program C3 among the plurality of execution object programs are programs of the type C.

The obtaining unit 92 obtains information about the execution time of each of the plurality of types of program. Specifically, the obtaining unit 92 obtains information indicating that: the execution time of a program of the type A is the execution time “a”; the execution time of a program of the type B is the execution time “b” shorter than the execution time “a”; and the execution time of a program of the type C is the execution time “c” longer than the execution time “a”. As described above, in the first embodiment, since the sum of the execution time “a” and the execution time “b” is equal to the execution time “c”, the obtaining unit 92 also obtains information indicating that the sum of the execution time “a” and the execution time “b” is equal to the execution time “c”.

The combining unit 93 creates a plurality of combinations for cases where each of the plurality of execution object programs is assigned to any one of the first PLC 1, the second PLC 6, and the third PLC 7, which are an example of the plurality of control devices. The combining unit 93 creates one combination by assigning at least two execution object programs mutually different in execution time to any one of the first PLC 1, the second PLC 6, and the third PLC 7, or by assigning them to any two of or all of the first PLC 1, the second PLC 6, and the third PLC 7.

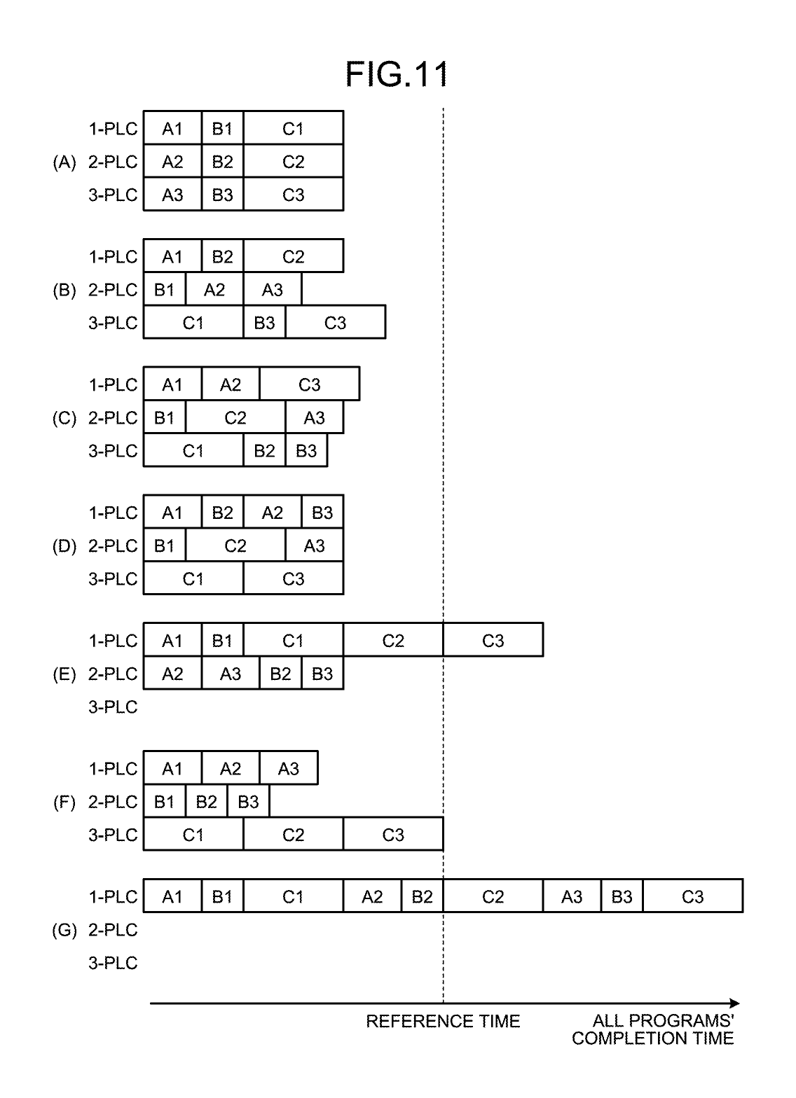

Here, with reference to FIG. 11, a plurality of combinations created by the combining unit 93 will be explained. FIG. 11 is a view illustrating combination examples created by the combining unit 93 of FIG. 10. The combining unit 93 creates a plurality of combinations including five combinations illustrated in FIG. 11(A) to FIG. 11(E). Specifically, as illustrated in FIG. 11(A), the combining unit 93 creates one combination such that: the program A1, the program B1, and the program C1 are assigned to the first PLC 1; the program A2, the program B2, and the program C2 are assigned to the second PLC 6; and the program A3, the program B3, and the program C3 are assigned to the third PLC 7. In FIG. 11, “1-PLC” means the first PLC 1, “2-PLC” means the second PLC 6, and “3-PLC” means the third PLC 7.

In addition, as illustrated in FIG. 11(B), the combining unit 93 creates one combination such that: the program A1, the program B2, and the program C2 are assigned to the first PLC 1; the program B1, the program A2, and the program A3 are assigned to the second PLC 6; and the program C1, the program B3, and the program C3 are assigned to the third PLC 7.

Further, as illustrated in FIG. 11(C), the combining unit 93 creates one combination such that: the program A1, the program A2, and the program C3 are assigned to the first PLC 1; the program B1, the program C2, and the program A3 are assigned to the second PLC 6; and the program C1, the program B2, and the program B3 are assigned to the third PLC 7.

Furthermore, as illustrated in FIG. 11(D), the combining unit 93 creates one combination such that: the program A1, the program B2, the program A2, and the program B3 are assigned to the first PLC 1; the program B1, the program C2, and the program A3 are assigned to the second PLC 6; and the program C1 and the program C3 are assigned to the third PLC 7.

Furthermore, as illustrated in FIG. 11(E), the combining unit 93 creates one combination such that: the program A1, the program B1, the program C1, the program C2, and the program C3 are assigned to the first PLC 1; and the program A2, the program A3, the program B2, and the program B3 are assigned to the second PLC 6.

For each of the plurality of combinations created by the combining unit 93, the estimating unit 94 estimates an all programs' completion time, which is a delay time taken from the delivery of the plurality of execution object programs until the return of execution results of the plurality of execution object programs to the delivery source. Specifically, the estimating unit 94 presumes that execution times for respectively executing programs of the same type are equal to each other, and uses information caught by the specifying unit 91 and information obtained by the obtaining unit 92, whereby, for each of the plurality of combinations created by the combining unit 93, the estimating unit 94 estimates the all programs' completion time, which is a delay time taken from the delivery of the plurality of execution object programs until the return of execution results of the plurality of execution object programs to the delivery source. The information caught by the specifying unit 91 is information that specifies each of the plurality of execution object programs as to which one of the plurality of types of program is. The information obtained by the obtaining unit 92 is information about the execution time of each of the plurality of types of program.

With reference to FIG. 11, a function of the estimating unit 94 will be further explained. As described above, FIG. 11 is the view illustrating combination examples created by the combining unit 93 of FIG. 10, but this is also a view illustrating estimation results of the all programs' completion time, respectively for the plurality of combinations created by the combining unit 93. The all programs' completion time means a delay time taken from the delivery of the plurality of execution object programs until the return of execution results of the plurality of execution object programs to the delivery source.

In the combination of FIG. 11(A), the all programs' completion time is a time necessary for the first PLC 1 to execute the program A1, the program B1, and the program C1, and is a time of the sum of the execution time “a”, the execution time “b”, and the execution time “c”. The execution time necessary for the second PLC 6 to execute the program A2, the program B2, and the program C2 is equal to the execution time necessary for the first PLC 1 to execute the program A1, the program B1, and the program C1. Also, the execution time necessary for the third PLC 7 to execute the program A3, the program B3, and the program C3 is equal to the execution time necessary for the first PLC 1 to execute the program A1, the program B1, and the program C1.

In the combination of FIG. 11(B), the all programs' completion time is a time necessary for the third PLC 7 to execute the program C1, the program B3, and the program C3, and is a time of the sum of the execution time “b” and twice the execution time “c”. In the combination of FIG. 11(C), the all programs' completion time is a time necessary for the first PLC 1 to execute the program A1, the program A2, and the program C3, and is a time of the sum of twice the execution time “a” and the execution time “c”.

In the combination of FIG. 11(D), the all programs' completion time is a time necessary for the first PLC 1 to execute the program A1, the program B2, the program A2, and the program B3, and is a time of the sum of twice the execution time “a” and twice the execution time “b”. As described above, the sum of the execution time “a” and the execution time “b” is equal to the execution time “c”, and so, in the combination of FIG. 11(D), the all programs' completion time is a time necessary for the second PLC 6 to execute the program B1, the program C2, and the program A3, and is also a time of the sum of the execution time “b”, the execution time “c”, and the execution time “a”. In the combination of FIG. 11(D), the all programs' completion time is a time necessary for the third PLC 7 to execute the program C1 and the program C3, and is a time of twice the execution time “c”. Further, the all programs' completion time in the combination of FIG. 11(D) is equal to the all programs' completion time in the combination of FIG. 11(A).

In the combination of FIG. 11(E), the all programs' completion time is a time necessary for the first PLC 1 to execute the program A1, the program B1, the program C1, the program C2, and the program C3, and is a time of the sum of the execution time “a”, the execution time “b”, and three times the execution time “c”.

The calculating unit 95 calculates a reference time serving as a determination reference for selecting one combination from the plurality of combinations created by the combining unit 93. Specifically, the calculating unit 95 presumes that execution times for respectively executing programs of the same type are equal to each other, and uses information caught by the specifying unit 91 and information obtained by the obtaining unit 92. Further, the calculating unit 95 assumes a case where programs of the same type included in the plurality of execution object programs are assigned to the same PLC of the first PLC 1, the second PLC 6, and the third PLC 7, which are an example of the plurality of control devices and where programs of mutually different types included in the plurality of execution object programs are respectively assigned to mutually different PLCs of the first PLC 1, the second PLC 6, and the third PLC 7. Then, for this assumed case, the calculating unit 95 calculates a reference time, which is a delay time taken from the delivery of the plurality of execution object programs until the return of execution results of the plurality of execution object programs to the delivery source.

With reference to FIG. 11, a function of the calculating unit 95 will be further explained. As described above, FIG. 11 is the view illustrating combination examples created by the combining unit 93 of FIG. 10, but this is also a view illustrating the reference time calculated by the calculating unit 95. As illustrated in FIG. 11(F), there is assumed a case where: the first PLC 1 executes the program A1, the program A2, and the program A3; the second PLC 6 executes the program B1, the program B2, and the program B3; and the third PLC 7 executes the program C1, the program C2, and the program C3. For the combination illustrated in FIG. 11(F), the calculating unit 95 calculates a reference time, which is a delay time taken from the delivery of the plurality of execution object programs until the return of execution results of the plurality of execution object programs to the delivery source. The reference time calculated by the calculating unit 95 is a time of three times the execution time “c”, as can be understood from FIG. 11(F).

FIG. 11(G) illustrates a combination in which nine programs, which are the program A1, the program B1, the program C1, the program A2, the program B2, the program C2, the program A3, the program B3, and the program C3, are assigned to the first PLC 1.

From the plurality of combinations created by the combining unit 93, the selecting unit 96 selects one combination whose all programs' completion time estimated by the estimating unit 94 is shorter than the reference time calculated by the calculating unit 95. As described above, the reference time serves as a determination reference for selecting one combination from the plurality of combinations created by the combining unit 93. For example, the selecting unit 96 selects a combination whose all programs' completion time estimated by the estimating unit 94 is shortest among the plurality of combinations created by the combining unit 93. In the examples of FIG. 11, since the combination of FIG. 11(A) or FIG. 11(D) has the shortest all programs' completion time, the selecting unit 96 selects the combination of FIG. 11(A) or FIG. 11(D) from the plurality of combinations created by the combining unit 93.

In a case where the selecting unit 96 has a rule not to select a combination in which a plurality of programs of the same type are assigned to any one of the PLCs, the selecting unit 96 selects the combination of FIG. 11(A), although the all programs' completion time in the combination of FIG. 11(A) is equal to the all programs' completion time in the combination of FIG. 11(D). This is because, in the combination of FIG. 11(D), a plurality of programs of the same type, which are the program C1 and the program C3, are assigned to the third PLC 7.

As described above, from the plurality of combinations created by the combining unit 93, the selecting unit 96 selects one combination whose all programs' completion time estimated by the estimating unit 94 is shorter than the reference time calculated by the calculating unit 95. The all programs' completion time in the combination of FIG. 11(B) and the all programs' completion time in the combination of FIG. 11(C) are also shorter than the reference time. Accordingly, the selecting unit 96 may select the combination of FIG. 11(B) or the combination of FIG. 11(C). In any case, the selecting unit 96 selects one combination whose all programs' completion time is shorter than the reference time, from the plurality of combinations. Accordingly, by use of the information terminal device 4 serving as the load distribution device, there is provided an effect capable of further shortening the all programs' completion time in a case arranged to execute a plurality of execution object programs by a plurality of control devices.

In accordance with the combination selected by the selecting unit 96, the controlling unit 97 assigns each of the plurality of execution object programs to any one of the first PLC 1, the second PLC 6, and the third PLC 7, to execute the plurality of execution object programs by the first PLC 1, the second PLC 6, and the third PLC 7. For example, if the combination selected by the selecting unit 96 is the combination of FIG. 11(A), the controlling unit 97 assigns the program A1, the program B1, and the program C1 to the first PLC 1 to execute them, assigns the program A2, the program B2, and the program C2 to the second PLC 6 to execute them, and assigns the program A3, the program B3, and the program C3 to the third PLC 7 to execute them.

The load detecting unit 98 detects the load of the first PLC 1. The first PLC 1 is an example of a specific control device of the plurality of control devices. The determining unit 99 determines whether the load detected by the load detecting unit 98 is not less than a threshold for performing a process of distributing the load. If the determining unit 99 determines that the load detected by the load detecting unit 98 is not less than the threshold, the specifying unit 91, the obtaining unit 92, the combining unit 93, the estimating unit 94, the calculating unit 95, the selecting unit 96, and the controlling unit 97 perform their own functions respectively. Here, the specifying unit 91, the obtaining unit 92, the combining unit 93, the estimating unit 94, the calculating unit 95, the selecting unit 96, and the controlling unit 97 may perform their own functions respectively, even in a case other than the case where the determining unit 99 determines that the load detected by the load detecting unit 98 is not less than the threshold.

The time detecting unit 79 detects an actual execution time of each of the plurality of execution object programs. The storing unit 78 stores information caught by the time detecting unit 79. The obtaining unit 92 may obtain information about the execution time of each of the plurality of types of program from the storing unit 78.

Specifically, the storing unit 78 stores the actual execution time of each of the plurality of execution object programs executed in the past. The obtaining unit 92 presumes that the execution time of programs of the same type is equal to the past execution time, and obtains information about the execution time of each of the plurality of types of program, from information stored in the storing unit 78. More specifically, there is assumed a case where the storing unit 78 stores the past execution time of the programs of the type A. The obtaining unit 92 may determine that the execution time of the programs of the type A to be executed in future is equal to the past execution time of the programs of the type A stored in the storing unit 78, and thereby obtain information about the past execution time of the programs of the type A stored in the storing unit 78, as information about the execution time of each of the program A1, the program A2, and the program A3 which are the programs of the type A.

As described above, the information terminal device 4 according to the first embodiment creates a plurality of combinations for cases where each of the plurality of execution object programs is assigned to any one of the first PLC 1, the second PLC 6, and the third PLC 7, which are an example of the plurality of control devices. For each of the plurality of combinations created, the information terminal device 4 estimates an all programs' completion time, which is a delay time taken from the delivery of the plurality of execution object programs until the return of execution results of the plurality of execution object programs to the delivery source. Then, from the plurality of combinations created, the information terminal device 4 selects one combination whose all programs' completion time estimated is shorter than the reference time calculated by the calculating unit 95. As a result, the information terminal device 4 can further shorten the all programs' completion time. When the selecting unit 96 of the information terminal device 4 selects a combination whose all programs' completion time is shortest among the plurality of combinations created, the information terminal device 4 can make the all programs' completion time shortest.

In the first embodiment described above, the combining unit 93 creates a plurality of combinations for cases where each of the plurality of execution object programs is assigned to any one of the first PLC 1, the second PLC 6, and the third PLC 7, which are an example of the plurality of control devices. In other words, the combining unit 93 creates one combination by assigning at least two execution object programs mutually contrary in execution time to at least one of the first PLC 1, the second PLC 6, and the third PLC 7, which are an example of the plurality of control devices.

The two execution object programs mutually contrary in execution time are two of the plurality of execution object programs arranged in the descending order of the length of the execution time, where one of them belongs to a plurality of programs from the highest rank to a preset first rank in the plurality of execution object programs thus arranged, and the other belongs to a plurality of programs from a preset second rank, which is lower than the first rank, to the lowest rank in the plurality of execution object programs thus arranged. The first rank is a rank lower than the highest rank, and the second rank is a rank higher than the lowest rank.

In the combination of FIG. 11(F), only the programs of the type A are assigned to the first PLC 1, only the programs of the type B are assigned to the second PLC 6, and only the programs of the type C are assigned to the third PLC 7. In other words, in the combination of FIG. 11(F), two execution object programs mutually contrary in execution time are not assigned to any one of the first PLC 1, the second PLC 6, and the third PLC 7. Accordingly, if there is provided a rule to create one combination by assigning at least two execution object programs mutually contrary in execution time to at least one of the first PLC 1, the second PLC 6, and the third PLC 7, which are an example of the plurality of control devices, the combining unit 93 does not create the combination of FIG. 11(F).

An example of the two execution object programs mutually contrary in execution time is formed of one program whose execution time is longest and one program whose execution time is shortest, among the plurality of execution object programs. In the first embodiment, an example of the two execution object programs mutually contrary in execution time is formed of one program of the type B and one program of the type C.

In the first embodiment described above, the reference time is calculated by the calculating unit 95. However, the reference time may be not calculated by the calculating unit 95, but may be a time determined in advance. If the reference time is a time predetermined, the selecting unit 96 selects one combination whose all programs' completion time estimated by the estimating unit 94 is shorter than this predetermined reference time, from the plurality of combinations created by the combining unit 93. By setting the reference time properly, the information terminal device 4 can further shorten the all programs' completion time.

In the first embodiment described above, the combining unit 93 creates a plurality of combinations for cases where each of the plurality of execution object programs is assigned to any one of the first PLC 1, the second PLC 6, and the third PLC 7, which are an example of the plurality of control devices. However, the combining unit 93 may create only one combination such that at least two execution object programs mutually contrary in execution time among the plurality of execution object programs are assigned to at least one of the first PLC 1, the second PLC 6, and the third PLC 7, which are an example of the plurality of control devices. In this case, in accordance with the combination created by the combining unit 93, the controlling unit 97 assigns each of the plurality of execution object programs to any one of the first PLC 1, the second PLC 6, and the third PLC 7, to execute the plurality of execution object programs by the first PLC 1, the second PLC 6, and the third PLC 7. Also in this case, the all programs' completion time is further shortened. Since the two execution object programs mutually contrary in execution time have been described above, an explanation about them will be omitted here.

In the first embodiment described above, an example of the plurality of control devices is the first PLC 1, the second PLC 6, and the third PLC 7. However, the plurality of control devices are not limited to the three PLCs composed of the first PLC 1, the second PLC 6, and the third PLC 7. The plurality of control devices may be two PLCs composed of the first PLC 1 and the second PLC 6, or may be four or more PLCs. For example, the number of the plurality of control devices is determined in consideration of the production cost in a case where a plurality of PLCs are used under conditions for producing a certain product.

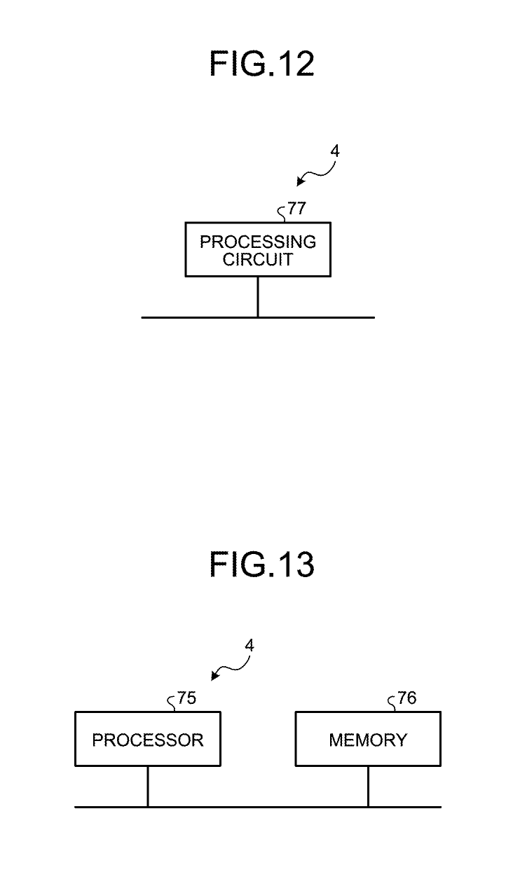

As regards the specifying unit 91, the obtaining unit 92, the combining unit 93, the estimating unit 94, the calculating unit 95, the selecting unit 96, the controlling unit 97, the load detecting unit 98, the determining unit 99, and the time detecting unit 79, which constitute the information terminal device 4, some or all of their functions may be realized by a processing circuit 77. FIG. 12 is a view illustrating a case where at least some of the units constituting the information terminal device 4 of FIG. 10 are formed of the processing circuit 77. The processing circuit 77 is dedicated hardware. Specifically, for example, the processing circuit 77 is a single circuit, combined circuit, programmed processor, parallel-programmed processor, ASIC (Application Specific Integrated Circuit), FPGA (Field-Programmable Gate Array), or combination thereof. As regards the specifying unit 91, the obtaining unit 92, the combining unit 93, the estimating unit 94, the calculating unit 95, the selecting unit 96, the controlling unit 97, the load detecting unit 98, the determining unit 99, and the time detecting unit 79, which constitute the information terminal device 4, some of them may be formed of dedicated hardware separate from the rest of them.

As regards the specifying unit 91, the obtaining unit 92, the combining unit 93, the estimating unit 94, the calculating unit 95, the selecting unit 96, the controlling unit 97, the load detecting unit 98, the determining unit 99, and the time detecting unit 79, which constitute the information terminal device 4, some or all of them may be formed of a processor 75 that executes programs stored in a memory 76. FIG. 13 is a view illustrating a case where at least some of the units constituting the information terminal device 4 of FIG. 10 are formed of the processor 75. The processor 75 is a CPU (Central Processing Unit), processing device, computing device, micro processor, micro computer, or DSP (Digital Signal Processor).

In a case where at least some of the units constituting the information terminal device 4 are formed of the processor 75, the functions of at least some of the units constituting the information terminal device 4 are realized by the processor 75 and software, firmware, or combination of software and firmware. The software or firmware is described as programs and stored in the memory 76. The processor 75 reads programs stored in the memory 76 and executes them to realize the functions of some of the units constituting the information terminal device 4.

Specifically, in a case where some of the units constituting the information terminal device 4 are formed of the processor 75, the information terminal device 4 includes the memory 76 for storing programs to realize the steps to be performed by some of the units constituting the information terminal device 4, as a result of execution. Thus, the programs stored in the memory 76 can be regarded as programs to cause a computer to perform the sequence or method of some of the units constituting the information terminal device 4. For example, the memory 76 is formed of: a nonvolatile or volatile semiconductor memory, such as a RAM (Random Access Memory), ROM (Read Only Memory), flash memory, EPROM (Erasable Programmable Read Only Memory), or EEPROM (Electrically Erasable Programmable Read-Only Memory); magnetic disk; flexible disk; optical disk; compact disk; mini disk; or DVD.

As regards the plurality of units constituting the information terminal device 4, some of their functions may be realized by dedicated hardware, and the rest may be realized by software or firmware. In this way, as regards the plurality of units constituting the information terminal device 4, hardware, software, firmware, or combination thereof may be used to realize the functions of the plurality of units constituting the information terminal device 4.

The configurations illustrated in the above embodiment are mere examples of the contents of the present invention, and they may be combined with other known techniques. Further, the configurations may be partly omitted or changed without departing from the spirit of the present invention.

### REFERENCE SIGNS LIST

1 first PLC, 4 information terminal device, 6 second PLC, 7 third PLC, 49 load distribution processing unit, 78 storing unit, 79 time detecting unit, 91 specifying unit, 92 obtaining unit, 93 combining unit, 94 estimating unit, 95 calculating unit, 96 selecting unit, 97 controlling unit, 98 load detecting unit, 99 determining unit.

1. A load distribution device for causing a plurality of execution object programs to be executed by a plurality of control devices, the load distribution device comprising:
a specifying unit to specify each of the plurality of execution object programs as to which one of a plurality of types of program is;
an obtaining unit to obtain information about an execution time of each of the plurality of types of program;
a combining unit to create a plurality of combinations for cases where each of the plurality of execution object programs is assigned to any one of the plurality of control devices;
an estimating unit to estimate an all programs' completion time, which is a delay time taken from delivery of the plurality of execution object programs until return of execution results of the plurality of execution object programs to a delivery source, for each of the plurality of combinations created by the combining unit, by presuming that execution times for respectively executing programs of a same type are equal to each other, and by using information caught by the specifying unit and information obtained by the obtaining unit;
a selecting unit to select one combination whose all programs' completion time estimated by the estimating unit is shorter than a reference time, from the plurality of combinations created by the combining unit;
a controlling unit to assign each of the plurality of execution object programs to any one of the plurality of control devices in accordance with the one combination selected by the selecting unit, to be executed the plurality of execution object programs by the plurality of control devices; and
a calculating unit to calculate the reference time, which is a delay time taken from delivery of the plurality of execution object programs until return of execution results of the plurality of execution object programs to a delivery source, by presuming that execution times for respectively executing programs of a same type are equal to each other, and by using information caught by the specifying unit and information obtained by the obtaining unit, the reference time standing for a case where programs of a same type included in the plurality of execution object programs are assigned to a same control device of the plurality of control devices and where programs of mutually different types included in the plurality of execution object programs are respectively assigned to mutually different control devices of the plurality of control devices,
wherein the selecting unit selects the one combination whose all programs' completion time estimated by the estimating unit is shorter than the reference time calculated by the calculating unit, from the plurality of combinations created by the combining unit.

2. (canceled)

3. The load distribution device according to claim 1, wherein the combining unit creates one combination by assigning two of the execution object programs mutually different in the execution time to at least one of the plurality of control devices.

4. The load distribution device according to claim 1, wherein the combining unit creates one combination by assigning two of the execution object programs mutually contrary in the execution time to at least one of the plurality of control devices, and
wherein the two of the execution object programs mutually contrary in the execution time are two of the plurality of execution object programs arranged in a descending order of a length of the execution time, where one of the two belongs to a plurality of programs from a highest rank to a preset first rank in the plurality of execution object programs, and another belongs to a plurality of programs from a preset second rank, which is lower than the first rank, to a lowest rank in the plurality of execution object programs.

5. The load distribution device according to claim 4, wherein the two of the execution object programs mutually contrary in the execution time are one program whose execution time is longest and one program whose execution time is shortest, among the plurality of execution object programs.

6. The load distribution device according to claim 1, further comprising:
a load detecting unit to detect a load of a specific control device of the plurality of control devices; and
a determining unit to determine whether a load detected by the load detecting unit is not less than a threshold for performing a process of distributing a load,
wherein, if the determining unit determines that a load detected by the load detecting unit is not less than the threshold, the specifying unit, the obtaining unit, the combining unit, the estimating unit, the selecting unit and the controlling unit perform their own functions respectively.

7. The load distribution device according to claim 1, further comprising:
a time detecting unit to detect an actual execution time of each of the plurality of execution object programs; and
a storing unit to store information caught by the time detecting unit,
wherein the obtaining unit obtains information about an execution time of each of the plurality of types of program from the storing unit.

8. The load distribution device according to claim 1, wherein the selecting unit selects a combination whose all programs' completion time estimated by the estimating unit is shortest, from the plurality of combinations created by the combining unit.

9-17. (canceled)
